(19) United States
(12) Patent Application Publication
(10) Pub. No.: US 2025/0317955 A1
(43) Pub. Date: Oct. 9, 2025

(54) CROSS LINK INTERFERENCE MEASUREMENT CONFIGURATIONS FOR SUB-BAND FULL DUPLEX

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/626,046

(22) Filed: Apr. 3, 2024

(51) Int. Cl. H04W 72/541; H04L 5/14; H04W 72/0446; H04W 72/0453

(52) U.S. Cl. CPC H04W 72/541; H04L 5/14; H04W 72/0446; H04W 72/0453

(57) ABSTRACT

Methods, systems, and devices for wireless communications are described. The described techniques provide for a user equipment (UE) to select physical resource blocks (PRBs) for performing a cross link interference (CLI) measurement according to an overlap between sub-band full duplex (SBFD) resources and active bandwidth parts (BWPs) configured for the UE. The UE may be configured to communicate via an active uplink BWP, an active downlink BWP, or both, which may overlap with downlink sub-bands and uplink sub-bands of the SBFD resources. In such examples, the UE may perform CLI measurements via PRBs shared between the active BWP of the UE and a portion of the SBFD resources. Additionally, or alternatively, the UE may be configured to skip or drop CLI measurement occasions that occur during half-duplex slots, such as when the CLI measurement occasions are configured to occur periodically.

### FIELD OF TECHNOLOGY

The following relates to wireless communications, including cross link interference (CLI) measurement configurations for sub-band full duplex (SBFD).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may support communications via sub-band full duplex (SBFD) slots. Such slots may include sub-bands associated with both uplink communications and downlink communications. In some examples, the UE may experience interference associated with SBFD communications, such as cross link interference (CLI).

### SUMMARY

The described techniques relate to improved methods, systems, devices, and apparatuses that support cross link interference (CLI) measurement configurations for sub-band full duplex (SBFD). For example, the described techniques provide for a user equipment (UE) to select physical resource blocks (PRBs) for performing a CLI measurement according to an overlap between SBFD resources (e.g., configured for a cell that serves the UE) and active bandwidth parts (BWPs) configured for the UE. For example, the UE may be configured to communicate via an active uplink BWP, an active downlink BWP, or both (e.g., UE-configured frequency resources), which may overlap with portions of a downlink sub-band and an uplink sub-band of the SBFD resources. In such examples, the UE may perform CLI measurements via ‘usable’ PRBs, which may refer to PRBs shared between the active BWP of the UE and a portion of the SBFD resources. Such PRBs may be determined according to an overlap between a downlink sub-band and an active BWP, an uplink sub-band and an active BWP, a guard band and an active BWP, or any combination thereof. Additionally, or alternatively, the UE may be configured to skip or drop CLI measurement occasions that occur during half-duplex slots (e.g., slots associated with a single communication direction), such as when the CLI measurement occasions are configured to occur periodically.

A method for wireless communications by a UE is described. The method may include receiving an indication of one or more time domain resources associated with a CLI measurement by the UE, performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE, and transmitting a report including a CLI value in accordance with performing the CLI measurement.

A UE for wireless communications is described. The UE may include a processing system that includes processor circuitry and memory circuitry that stores code. The processing system may be configured to cause the UE to receive an indication of one or more time domain resources associated with a CLI measurement by the UE, perform, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE, and transmit a report including a CLI value in accordance with performing the CLI measurement.

Another UE for wireless communications is described. The UE may include means for receiving an indication of one or more time domain resources associated with a CLI measurement by the UE, means for performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE, and means for transmitting a report including a CLI value in accordance with performing the CLI measurement.

A non-transitory computer-readable medium storing code for wireless communications is described. The code may include instructions executable by one or more processors to receive an indication of one or more time domain resources associated with a CLI measurement by the UE, perform, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE, and transmit a report including a CLI value in accordance with performing the CLI measurement.

Some examples of the method, UEs, and non-transitory computer-readable medium described herein may further include operations, features, means, or instructions for selecting the one or more PRBs in accordance with an overlap between a first portion of the first frequency resources and the second frequency resources, where the first portion of the first frequency resources include at least one downlink sub-band and the second frequency resources include an active downlink BWP of the UE.

Some examples of the method, UEs, and non-transitory computer-readable medium described herein may further include operations, features, means, or instructions for selecting the one or more PRBs in accordance with an overlap between a first portion of the first frequency resources and the second frequency resources, where the first portion of the first frequency resources include at least one uplink sub-band and the second frequency resources include an active uplink BWP of the UE.

Some examples of the method, UEs, and non-transitory computer-readable medium described herein may further include operations, features, means, or instructions for selecting a subset of the one or more PRBs in accordance with an overlap between the one or more PRBs and third frequency resources configured for the UE, the third frequency resources associated with an active downlink BWP of the UE, where the CLI measurement may be performed via the subset of the one or more PRBs.

Some examples of the method, UEs, and non-transitory computer-readable medium described herein may further include operations, features, means, or instructions for selecting the one or more PRBs in accordance with an overlap between a first portion of the first frequency resources and the second frequency resources, where the first portion of the first frequency resources include at least one uplink sub-band and the second frequency resources include an active downlink BWP of the UE.

Some examples of the method, UEs, and non-transitory computer-readable medium described herein may further include operations, features, means, or instructions for selecting the one or more PRBs in accordance with an overlap between a first portion of the first frequency resources and the second frequency resources, where the first portion of the first frequency resources include at least one uplink sub-band and the second frequency resources include an active downlink BWP of the UE.

Some examples of the method, UEs, and non-transitory computer-readable medium described herein may further include operations, features, means, or instructions for selecting the one or more PRBs in accordance with an overlap between one or more first portions of the first frequency resources and the second frequency resources, where the one or more first portions of the first frequency resources include one or more guard bands configured between one or more uplink sub-bands and one or more downlink sub-bands of the first frequency resources and the second frequency resources include an active downlink BWP of the UE.

In some examples of the method, UEs, and non-transitory computer-readable medium described herein, performing the CLI measurement may include operations, features, means, or instructions for measuring one or more of a received signal strength indicator (RSSI) and a reference signal received power (RSRP) via the one or more PRBs.

In some examples of the method, UEs, and non-transitory computer-readable medium described herein, the one or more PRBs may be SBFD frequency resources.

A method for wireless communications by a UE is described. The method may include receiving an indication of one or more time domain resources associated with a CLI measurement by the UE and skipping, during a first time domain resource of the one or more time domain resources, a first CLI measurement occasion configured for the first time domain resource in accordance with an overlap between the first time domain resource and a first slot that is configured as a half-duplex slot associated with a time domain duplexing configuration.

A UE for wireless communications is described. The UE may include one or more memories storing processor executable code, and one or more processors coupled with the one or more memories. The one or more processors may individually or collectively be operable to execute the code to cause the UE to receive an indication of one or more time domain resources associated with a CLI measurement by the UE and skip, during a first time domain resource of the one or more time domain resources, a first CLI measurement occasion configured for the first time domain resource in accordance with an overlap between the first time domain resource and a first slot that is configured as a half-duplex slot associated with a time domain duplexing configuration.

Another UE for wireless communications is described. The UE may include means for receiving an indication of one or more time domain resources associated with a CLI measurement by the UE and means for skipping, during a first time domain resource of the one or more time domain resources, a first CLI measurement occasion configured for the first time domain resource in accordance with an overlap between the first time domain resource and a first slot that is configured as a half-duplex slot associated with a time domain duplexing configuration.

A non-transitory computer-readable medium storing code for wireless communications is described. The code may include instructions executable by one or more processors to receive an indication of one or more time domain resources associated with a CLI measurement by the UE and skip, during a first time domain resource of the one or more time domain resources, a first CLI measurement occasion configured for the first time domain resource in accordance with an overlap between the first time domain resource and a first slot that is configured as a half-duplex slot associated with a time domain duplexing configuration.

In some examples of the method, UEs, and non-transitory computer-readable medium described herein, the one or more time domain resources correspond to periodic CLI measurement occasions including at least the first CLI measurement occasion.

Some examples of the method, UEs, and non-transitory computer-readable medium described herein may further include operations, features, means, or instructions for omitting the first CLI measurement occasion from an update process of an accumulated filter result associated with the CLI in accordance with skipping the first CLI measurement occasion.

Some examples of the method, UEs, and non-transitory computer-readable medium described herein may further include operations, features, means, or instructions for performing, during a second time domain resource of the one or more time domain resources, a second CLI measurement occasion configured for the second time domain resource in accordance with an overlap between the second time domain resource and a second slot that may be configured as a SBFD slot.

### BRIEF DESCRIPTION OF THE DRAWINGS

FIG. 1 shows an example of a wireless communications system that supports cross link interference (CLI) measurement configurations for sub-band full duplex (SBFD) in accordance with one or more aspects of the present disclosure.

FIG. 2 shows an example of a wireless communications system that supports CLI measurement configurations for SBFD in accordance with one or more aspects of the present disclosure.

FIG. 3 shows an example of a physical resource block (PRB) selection scheme that supports CLI measurement configurations for SBFD in accordance with one or more aspects of the present disclosure.

FIGS. 4A and 4B show examples of PRB selection schemes that support CLI measurement configurations for SBFD in accordance with one or more aspects of the present disclosure.

FIGS. 5A and 5B show examples of PRB selection schemes that support CLI measurement configurations for SBFD in accordance with one or more aspects of the present disclosure.

FIG. 6 shows an example of a CLI measurement scheme that supports CLI measurement configurations for SBFD in accordance with one or more aspects of the present disclosure.

FIG. 7 shows an example of a process flow that supports CLI measurement configurations for SBFD in accordance with one or more aspects of the present disclosure.

FIGS. 8 and 9 show block diagrams of devices that support CLI measurement configurations for SBFD in accordance with one or more aspects of the present disclosure.

FIG. 10 shows a block diagram of a communications manager that supports CLI measurement configurations for SBFD in accordance with one or more aspects of the present disclosure.

FIG. 11 shows a diagram of a system including a device that supports CLI measurement configurations for SBFD in accordance with one or more aspects of the present disclosure.

FIGS. 12 and 13 show flowcharts illustrating methods that support CLI measurement configurations for SBFD in accordance with one or more aspects of the present disclosure.

### DETAILED DESCRIPTION

In some wireless communications systems, a user equipment (UE) may be configured to support sub-band full duplex (SBFD) communications between the UE and one or more other wireless devices. For example, the UE may be an SBFD aware UE (or SBFD-enabled UE) configured to communicate via SBFD slots, which may be examples of slots including sets of frequency resources (e.g., sub-bands) associated with different communication directions, which may support the UE communicating via uplink communications and downlink communications simultaneously. In some examples, the UE may experience interference, such as cross link interference (CLI), due to communications by other SBFD aware devices. As an example, the UE may receive, via a downlink sub-band of an SBFD slot, an uplink signal transmitted by another UE associated with a different cell (e.g., due to different SBFD configurations per cell). To mitigate CLI, the UE may measure and report CLI values to a network entity. However, the UE may be unaware of which frequency resources are available for CLI measurement, which may result in the UE being unable to perform CLI measurements, thereby reducing performance of SBFD communications.

To identify frequency resources for performing CLI measurements, a UE may select physical resource blocks (PRBs) for performing a CLI measurement according to an overlap between SBFD resources (e.g., configured for a cell that serves the UE) and active bandwidth parts (BWPs) configured for the UE. For example, the UE may be configured to communicate via an active uplink BWP, an active downlink BWP, or both (e.g., UE-configured frequency resources), which may overlap with portions of both a downlink sub-band and an uplink sub-band of the SBFD resources (e.g., cell-specific frequency resources). In such examples, the UE may perform CLI measurements via ‘usable’ PRBs, which may refer to PRBs shared between the active BWP of the UE and a portion of the SBFD resources. Such PRBs may be determined according to an overlap between a downlink sub-band and an active BWP, an uplink sub-band and an active BWP, a guard band and an active BWP, or any combination thereof. Additionally, or alternatively, the UE may be configured to skip or drop CLI measurement occasions that occur during half-duplex slots (e.g., slots associated with a single communication direction), such as when the CLI measurement occasions are configured to occur periodically. Such techniques may improve performance and accuracy of CLI measurements by an SBFD aware UE, thereby improving SBFD communications.

Aspects of the disclosure are initially described in the context of wireless communications systems. Aspects of the disclosure are further illustrated by and described with reference to PRB selection schemes, a CLI measurement scheme, and a process flow. Aspects of the disclosure are further illustrated by and described with reference to apparatus diagrams, system diagrams, and flowcharts that relate to CLI measurement configurations for SBFD.

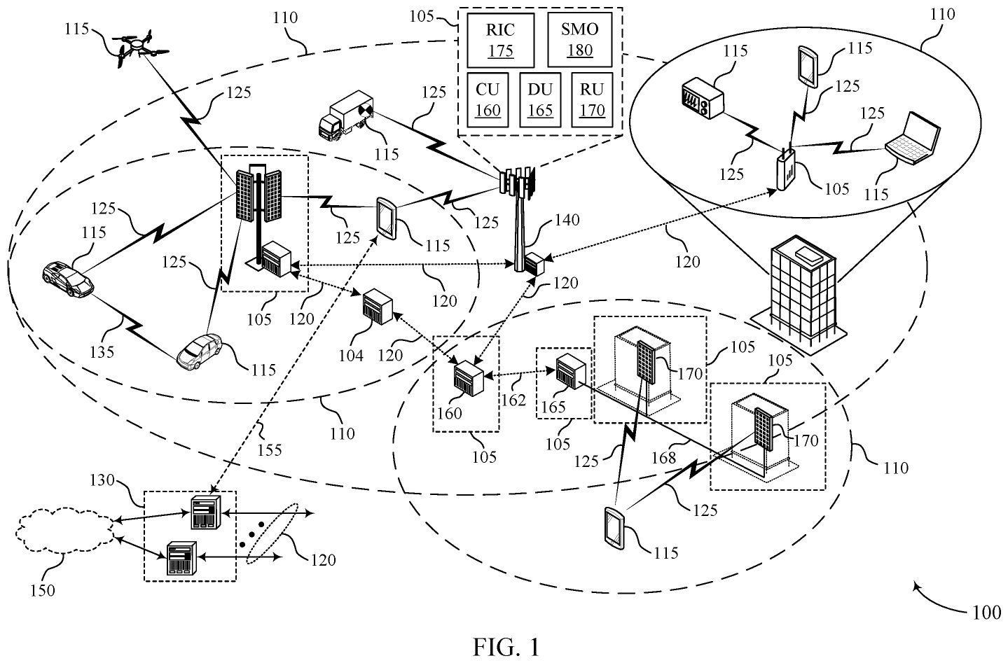

FIG. 1 shows an example of a wireless communications system 100 that supports CLI measurement configurations for SBFD in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, a UE 115 may be an example of an SBFD aware UE and may support communications via SBFD slots. For example, the UE 115 may support simultaneous transmission via uplink resources (e.g., one or more uplink sub-bands) and reception via downlink resources (e.g., one or more downlink sub-bands) associated with an SBFD slot. In some cases, the UE 115 may experience interference, such as CLI, due to communications by other SBFD wireless devices. For instance, the UE 115 may receive, via a downlink sub-band of an SBFD slot, an uplink signal transmitted by another UE. Such CLI may be an example of inter-sub-band intra-cell CLI (e.g., interference from another UE 115 served by the same cell as the UE 115), inter-sub-band inter-cell CLI (e.g., interference from another UE 115 served by a different cell from the UE 115), or both, among other examples. In some examples, the UE 115 may measure CLI and report a value associated with the CLI measurement to a network entity 105, which may support mitigating CLI during subsequent SBFD slots. However, the UE 115 may be unaware of which frequency resources are available for CLI measurement, which may result in the UE 115 being unable to perform CLI measurements, thereby reducing performance of SBFD communications.

To identify frequency resources for performing CLI measurements, a UE 115 may select PRBs for performing a CLI measurement according to an overlap between SBFD resources (e.g., configured for a cell that serves the UE 115) and active BWPs configured for the UE 115. For example, the UE 115 may be configured to communicate via an active uplink BWP, an active downlink BWP, or both (e.g., UE-configured frequency resources), which may overlap with portions of both a downlink sub-band and an uplink sub-band of the SBFD resources (e.g., cell-specific frequency resources). In such examples, the UE 115 may perform CLI measurements via ‘usable’ PRBs, which may refer to PRBs shared between the active BWP of the UE 115 and a portion of the SBFD resources. Such PRBs may be determined according to an overlap between a downlink sub-band and an active BWP, an uplink sub-band and an active BWP, a guard band and an active BWP, or any combination thereof. Additionally, or alternatively, the UE 115 may be configured to skip or drop CLI measurement occasions that occur during half-duplex slots (e.g., slots associated with a single communication direction), such as when the CLI measurement occasions are configured to occur periodically. Such techniques may improve performance and accuracy of CLI measurements by an SBFD aware UE 115.

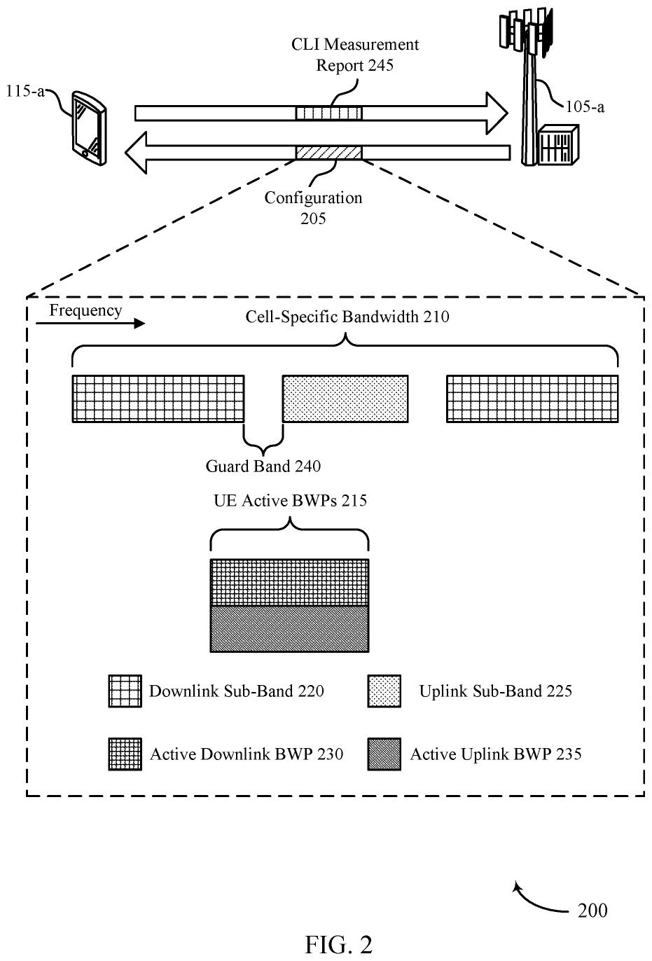

FIG. 2 shows an example of a wireless communications system 200 that supports CLI measurement configurations for SBFD in accordance with one or more aspects of the present disclosure. The wireless communications system 200 may implement, or be implemented by, one or more aspects of the wireless communications system 100. For example, the wireless communications system 200 may include signaling between a UE 115-a and a network entity 105-b, which may be examples of corresponding devices described with reference to FIG. 1. In some cases, the wireless communications system 200 may support the UE 115-a communicating via SBFD slots (e.g., the UE 115-a may be a SBFD aware UE 115) and performing CLI measurements via PRBs determined according to an overlap between SBFD resources configured for the network entity 105-b and active BWPs configured for the UE 115.

In some examples, the UE 115-a may receive an indication of a configuration 205, which may indicate a cell-specific bandwidth 210 and one or more UE active BWPs 215. The cell-specific bandwidth 210 may be an example of SBFD resources configured for the network entity 105-a (e.g., for serving one or more UEs 115 including at least the UE 115-a), which may include one or more downlink sub-bands 220 and one or more uplink sub-bands 225. In the example illustrated by the wireless communications system 200, during an SBFD slot, the network entity 105-a may support downlink communications via a first downlink sub-band 220, uplink communications via a first uplink sub-band 225, downlink communications via a second downlink sub-band 220, or any combination thereof. Additionally, one or more guard bands 240 may be configured between the downlink sub-bands 220 and the uplink sub-bands 225. The one or more UE active BWPs 215 may be examples of frequency resources configured for use by the UE 115-a for downlink communications and uplink communications. For example, the UE active BWPs 215 may include an active downlink BWP 230 and an active uplink BWP 235, which may share similar frequency resources (e.g., as illustrated by FIG. 2) or may include different sets of frequency resources (e.g., a partial overlap or no overlap between the active downlink BWP 230 and the active uplink BWP 235). It should be noted that while the wireless communications system 200 illustrates the UE active BWPs 215 overlapping one downlink sub-band 220 and one uplink sub-band 225, the techniques described herein may be relevant to the UE active BWPs 215 overlapping multiple downlink sub-bands 220, multiple uplink sub-bands 225, or any combination thereof.

The UE 115-a may experience interference during SBFD communications, such as CLI, which may be an example of interference due to SBFD communications by other wireless devices. For example, while monitoring a downlink sub-band 220 using resources of the active downlink BWP 230 for transmissions from the network entity 105-a, the UE 115-a may receive uplink signaling transmitted by another UE 115, which may be a UE 115 associated with a different serving cell (e.g., inter-cell CLI) or the same serving cell (e.g., intra-cell CLI).

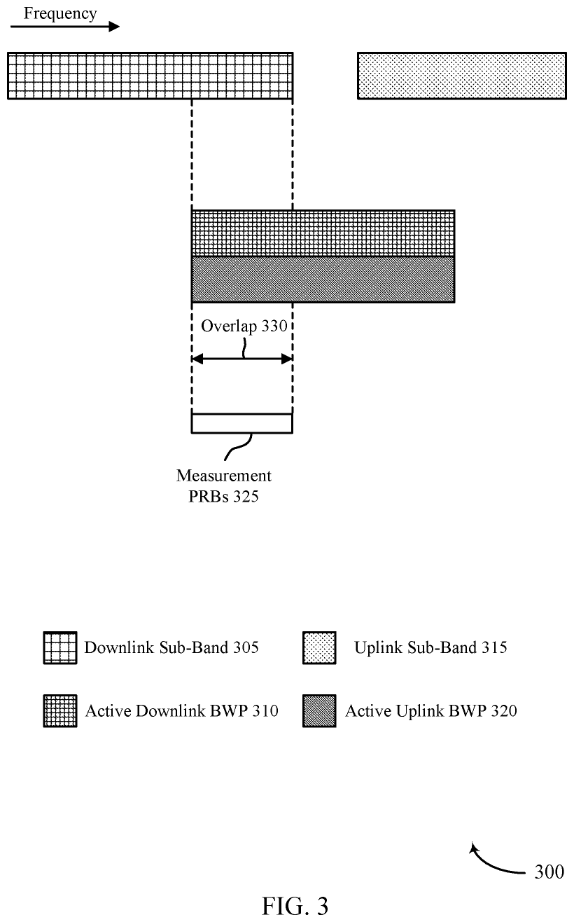

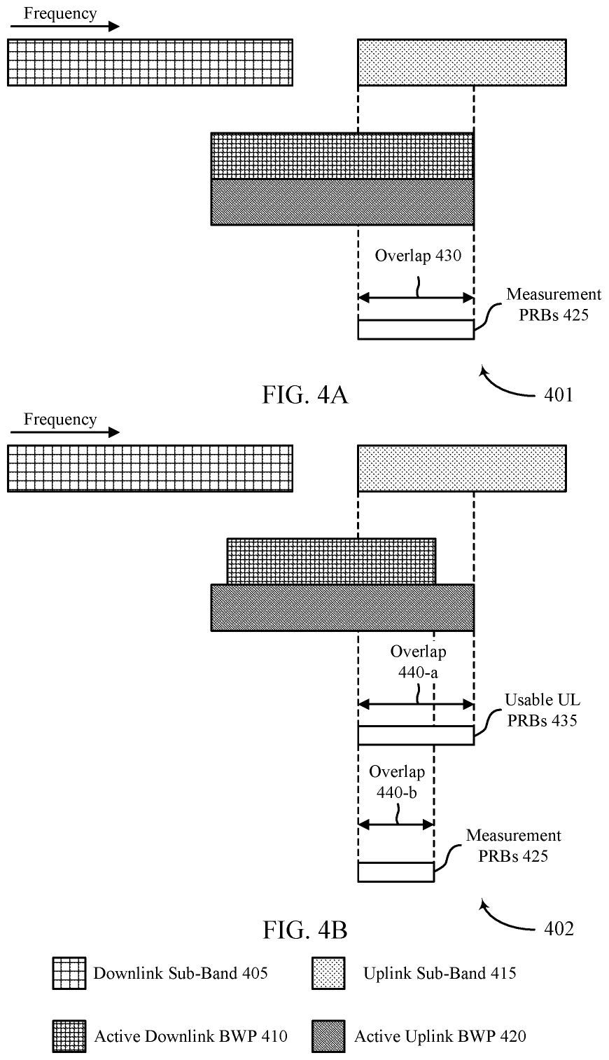

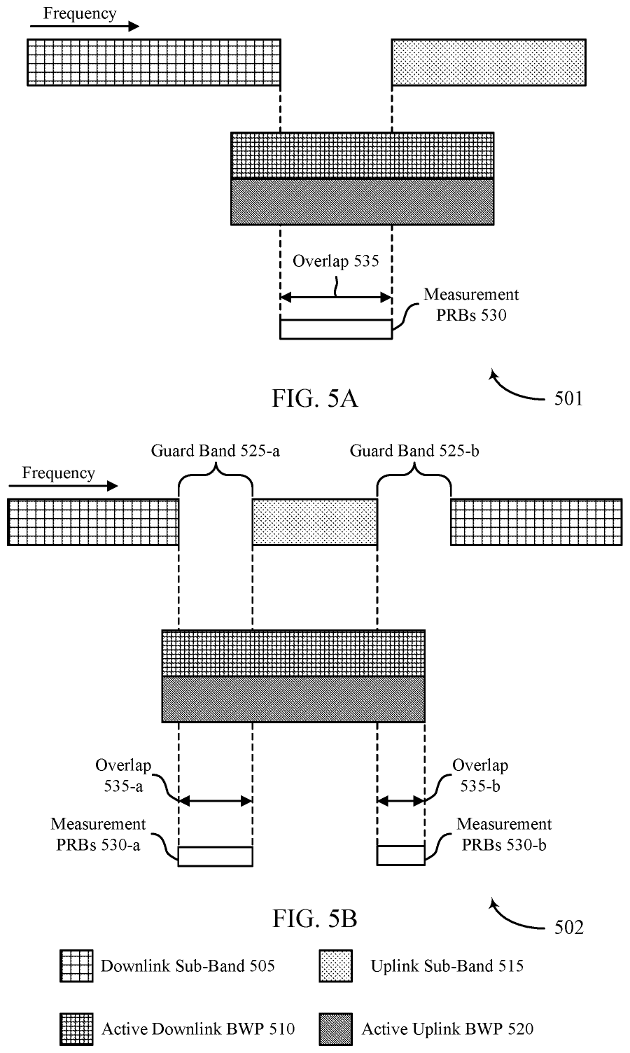

In some cases, the UE 115-a may measure CLI and report a value associated with the CLI measurement to the network entity 105-a, such as via a CLI measurement report 245. For example, the UE 115-a may measure the CLI value via one or more PRBs (e.g., referred to as ‘usable’ PRBs or measurement PRBs), where such PRBs may be determined (e.g., selected) according to an overlap between frequency resources of the cell-specific bandwidth 210 and the frequency resources of the UE active BWPs 215. In a first example, the measurement PRBs may be determined according to an overlap between a downlink sub-band 220 and the active downlink BWP 230 (as described in greater detail with respect to FIG. 3). In a second example, the measurement PRBs may be determined according to an overlap between an uplink sub-band 225, the active downlink BWP 230, and the active uplink BWP 235 (as described in greater detail with respect to FIGS. 4A and 4B). In a third example, the measurement PRBs may be determined according to an overlap between one or more guard bands 240 and the active downlink BWP 230 (as described in greater detail with respect to FIGS. 5A and 5B). It should be noted that such examples for determining measurement PRBs may be implemented individually or in any combination, and are not limited to the examples illustrated and described herein.

Additionally, or alternatively, the configuration 205 may indicate CLI measurement occasions for the UE 115-a to measure CLI. For example, the configuration 205 may indicate that the UE 115-a is to periodically measure slots for CLI. In some examples, such periodic CLI measurement occasions may occur during half-duplex slots (e.g., associated with a single communication direction), and performing a CLI measurement during a half-duplex slot may expend unnecessary energy at the UE 115-a (e.g., due to CLI not occurring during half-duplex slots). As such, the UE 115-a may be configured to drop (e.g., skip, refrain from, omit) a CLI measurement during a half-duplex slot. In some cases, if an accumulated filter associated with CLI measurement is enabled, the UE 115-a may omit a dropped CLI measurement from a process of updating the accumulated filter results (e.g., the UE 115-a may not update the accumulated filter results on a half-duplex slot).

Such techniques may improve SBFD communications by the UE 115-a due to identifying PRBs for CLI measurement which support accurate and consistent CLI measurement values, thereby improving CLI mitigation during subsequent communications.

FIG. 3 shows an example of a PRB selection scheme 300 that supports CLI measurement configurations for SBFD in accordance with one or more aspects of the present disclosure. The PRB selection scheme 300 may implement, or be implemented by, one or more aspects of the wireless communications systems 100 and 200. For example, the PRB selection scheme 300 may show an example of a UE 115 determining measurement PRBs for performing a CLI measurement, which may be an example of the UEs 115 described with reference to FIGS. 1 and 2. In some examples, the UE 115 may select the measurement PRBs according to an overlap, in the frequency domain, between SBFD resources configured for a cell serving the UE 115 (e.g., the network entity 105-a described with reference to FIG. 2) and an active BWP of the UE 115, which may be examples of corresponding aspects described with reference to FIG. 2. For example, the PRB selection scheme 300 may support the UE 115 selecting the measurement PRBs based on an overlap between a downlink sub-band 305 and an active downlink BWP 310.

In some cases, a cell-specific bandwidth may include SBFD resources, such as a downlink sub-band 305 and an uplink sub-band 315, which may be configured for a cell serving the UE 115. Additionally, the UE 115 may be configured to communicate via an active downlink BWP 310 and an active uplink BWP 320 (e.g., frequency resources within the cell-specific bandwidth that the UE 115 is to use for communications). In some examples, the UE 115 may perform a CLI measurement to obtain a value corresponding to a magnitude of CLI that occurs during a SBFD slot, which may be due to communications by other SBFD aware devices. For example, the UE 115 may measure one or more measurement PRBs 325 to obtain a received signal strength indicator (RSSI) associated with the CLI. In some examples, the UE 115 may identify (e.g., determine, select) the one or more measurement PRBs 325 to use for performing the CLI measurement according to an overlap 330, in the frequency domain, between a downlink sub-band 305 and the active downlink BWP 310. For example, the overlap 330 may indicate PRBs that are shared between the downlink sub-band 305 and the active downlink BWP 310 (e.g., CLI-RSSI frequency resources), which may be referred to as ‘usable’ downlink PRBs (e.g., PRBs that are suitable for both SBFD downlink communications and UE-specific downlink communications). In the example illustrated by the PRB selection scheme 300, the UE 115 may select the ‘usable’ downlink PRBs as the one or more measurement PRBs 325. The UE 115 may measure a CLI value via the one or more measurement PRBs 325 and may report the CLI value to a network entity 105 (e.g., a serving cell for the UE 115).

Such techniques may improve SBFD communications by the UE 115 due to identifying PRBs for CLI measurement which support accurate and consistent CLI measurement values, thereby improving CLI mitigation during subsequent communications.

FIGS. 4A and 4B show examples of PRB selection schemes 401 and 402 that support CLI measurement configurations for SBFD in accordance with one or more aspects of the present disclosure. The PRB selection schemes 401 and 402 may implement, or be implemented by, the wireless communications systems 100 and 200. For example, the PRB selection schemes 401 and 402 may show examples of a UE 115 determining measurement PRBs for performing a CLI measurement, which may be an example of the UEs 115 described with reference to FIGS. 1 and 2. In some examples, the UE 115 may select the measurement PRBs according to one or more overlaps, in the frequency domain, between SBFD resources configured for a cell serving the UE 115 (e.g., the network entity 105-a described with reference to FIG. 2) and one or more active BWPs of the UE 115, which may be examples of corresponding aspects described with reference to FIG. 2. For example, the PRB selection schemes 401 and 402 may support the UE 115 selecting the measurement PRBs based on an overlap between an uplink sub-band 415 and one or more active BWPs of the UE 115.

In some cases, a cell-specific bandwidth may include SBFD resources, such as a downlink sub-band 405 and an uplink sub-band 415, which may be configured for a cell serving the UE 115. Additionally, the UE 115 may be configured to communicate via an active downlink BWP 410 and an active uplink BWP 420 (e.g., frequency resources within the cell-specific bandwidth that the UE 115 is to use for communications). In some examples, the UE 115 may perform a CLI measurement to obtain a value corresponding to a magnitude of CLI that occurs during a SBFD slot, which may be due to communications by other SBFD aware devices. For example, the UE 115 may measure one or more measurement PRBs 425 to obtain a RSSI associated with the CLI, a reference signal received power (RSRP) associated with the CLI, or both. For example, the UE 115 may measure an RSRP of an aggressor UE 115 (e.g., signaling from another UE 115 that incurs CLI at the UE 115) or an RSSI value via the measurement PRBs 425.

The PRB selection scheme 401 illustrates a first example of the UE 115 selecting measurement PRBs based on an overlap between the uplink sub-band 415 and the one or more active BWPs of the UE 115. In some examples, the UE 115 may select the one or more measurement PRBs 425 according to an overlap 430, in the frequency domain, between an uplink sub-band 415 and the active uplink BWP 420. For example, the overlap 430 may indicate PRBs that are shared between the uplink sub-band 415 and the active uplink BWP 420 (e.g., CLI-RSSI frequency resources and/or sounding reference signal (SRS)-RSRP frequency resources). Such PRBs may be referred to as ‘usable’ uplink PRBs (e.g., PRBs that are suitable for both SBFD uplink communications and UE-specific uplink communications). In the example illustrated by the PRB selection scheme 401, the UE 115 may select the ‘usable’ uplink PRBs as the one or more measurement PRBs 425. In some examples, the UE 115 may select the one or more measurement PRBs 425 from the ‘usable’ uplink PRBs according to an additional overlap between the ‘usable’ uplink PRBs and the active downlink BWP 410, as described in greater detail with reference to FIG. 4B. The UE 115 may measure a CLI value (e.g., an RSSI and/or RSRP value) via the one or more measurement PRBs 425 and may report the CLI value to a network entity 105 (e.g., a serving cell for the UE 115).

The PRB selection scheme 402 illustrates a second example of the UE 115 selecting measurement PRBs based on one or more overlaps between the uplink sub-band 415, the active uplink BWP 420, and the active downlink BWP 410. For example, the UE 115 may identify one or more ‘usable’ uplink PRBs 435 according to an overlap 440-a between the uplink sub-band 415 and the active uplink BWP 420. In some cases, if the active downlink BWP 410 and the active uplink BWP 420 configured for the UE 115 do not share identical frequency resources, the UE 115 may determine the one or more measurement PRBs 425 according to an additional overlap 440-b between the ‘usable’ uplink PRBs 435 and the active downlink BWP 410. For example, the one or more measurement PRBs 425 may be examples of PRBs that are included in each of the ‘usable’ uplink PRBs 435 and the active downlink BWP 410 (e.g., to support the UE 115 performing measurements via resources configured for downlink communications). In the example illustrated by the PRB selection scheme 402, the UE 115 may select the measurement PRBs 425 from a subset of the ‘usable’ uplink PRBs 435 based on the overlap 440-b (e.g., due to the active uplink BWP 420 extending to only a portion of the ‘usable’ uplink PRBs 435). In another example, the active downlink BWP 410 may extend beyond the ‘usable’ uplink PRBs 435, and the one or more measurement PRBs 425 may include additional PRBs associated with the active downlink BWP 410 (e.g., the measurement PRBs 425 may be based on an overlap between the uplink sub-band 415 and the active downlink BWP 410).

Such techniques may improve SBFD communications by the UE 115 due to identifying PRBs for CLI measurement which support accurate and consistent CLI measurement values, thereby improving CLI mitigation during subsequent communications.

FIGS. 5A and 5B show examples of PRB selection schemes 501 and 502 that support CLI measurement configurations for SBFD in accordance with one or more aspects of the present disclosure. The PRB selection schemes 501 and 502 may implement, or be implemented by, the wireless communications systems 100 and 200. For example, the PRB selection schemes 501 and 502 may show examples of a UE 115 determining measurement PRBs for performing a CLI measurement, which may be an example of the UEs 115 described with reference to FIGS. 1 and 2. In some examples, the UE 115 may select the measurement PRBs according to one or more overlaps, in the frequency domain, between SBFD resources configured for a cell serving the UE 115 (e.g., the network entity 105-a described with reference to FIG. 2) and one or more active BWPs of the UE 115, which may be examples of corresponding aspects described with reference to FIG. 2. For example, the PRB selection schemes 501 and 502 may support the UE 115 selecting the measurement PRBs based on an overlap between one or more guard bands of the SBFD resources and one or more active BWPs of the UE 115.

In some cases, a cell-specific bandwidth may include SBFD resources, such as a downlink sub-band 505 and an uplink sub-band 515, which may be configured for a cell serving the UE 115. The SBFD resources may include one or more guard bands 525 configured between each downlink sub-band 505 and uplink sub-band 515 (e.g., frequency resources not configured for communications), which may reduce interference associated with multiple communication directions. Additionally, the UE 115 may be configured to communicate via an active downlink BWP 510 and an active uplink BWP 520 (e.g., frequency resources within the cell-specific bandwidth that the UE 115 is to use for communications). In some examples, the UE 115 may perform a CLI measurement to obtain a value corresponding to a magnitude of CLI that occurs during a SBFD slot, which may be due to communications by other SBFD aware devices. For example, the UE 115 may measure one or more measurement PRBs 530 to obtain a RSSI associated with the CLI.

The PRB selection scheme 501 illustrates a first example of the UE 115 selecting measurement PRBs based on an overlap between a guard band 525 and the one or more active BWPs of the UE 115. The guard band 525 may be an example of frequency resources configured between a downlink sub-band 505 and an uplink sub-band 515 and not associated with a communication direction (e.g., frequency resources not configured for communications by the UE 115). In some examples, the UE 115 may select the one or more measurement PRBs 530 according to an overlap 535, in the frequency domain, between the guard band 525 and the active downlink BWP 510. For example, the overlap 535 may indicate PRBs that are shared between the guard band 525 and the active downlink BWP 510 (e.g., CLI-RSSI frequency resources), and the

UE 115 may select the measurement PRBs 530 according to the overlap 535. For example, the measurement PRBs 530 may include PRBs that are outside ‘usable’ uplink and downlink PRBs (described with reference to FIGS. 3 through 4B) but within the active downlink BWP 510. In such examples, the measurement PRBs 530 may still be defined as ‘usable’ PRBs, despite being outside of an overlap between a downlink sub-band 525 or an uplink sub-band 515 and an active BWP of the UE 115. The UE 115 may measure a CLI value (e.g., an RSSI value) via the one or more measurement PRBs 530 and may report the CLI value to a network entity 105 (e.g., a serving cell for the UE 115).

The PRB selection scheme 502 illustrates a second example of the UE 115 selecting measurement PRBs based on an overlap between one or more guard bands 525 (e.g., a guard band 525-a and a guard band 525-b) and the one or more active BWPs of the UE 115. For example, the SBFD resources may include a first guard band 525-a configured between a first downlink sub-band 505 and an uplink sub-band 515 and may further include a second guard band 525-b configured between the uplink sub-band 515 and a second downlink sub-band 505. The UE 115 may identify one or more overlaps 535, in the frequency domain, between the one or more guard bands 525 and the active downlink BWP 510 to support selecting one or more measurement PRBs 530. For example, the UE 115 may select a first set of one or more measurement PRBs 530-a according to an overlap 535-a between the guard band 525-a and the active downlink BWP 510. In some examples, the overlap 535-a may include the entire guard band 525-a due to the active downlink BWP 510 overlapping the full guard band 525-a. Additionally, or alternatively, the UE 115 may select a second set of one or more measurement PRBs 530-b according to an overlap 535-b between the guard band 525-b and the active downlink BWP 510. In some cases, the overlap 535-b may include a portion of the guard band 525-b due to the active downlink BWP 510 overlapping only a portion of the guard band 525-b (e.g., the measurement PRBs 530-b remain within the active downlink BWP 510). The UE 115 may measure a CLI value (e.g., an RSSI value) via the one or more measurement PRBs 530-a, the one or more measurement PRBs 530-b, or both, and may report the CLI value to a network entity 105 (e.g., a serving cell for the UE 115).

Such techniques may improve SBFD communications by the UE 115 due to identifying PRBs for CLI measurement which support accurate and consistent CLI measurement values, thereby improving CLI mitigation during subsequent communications.

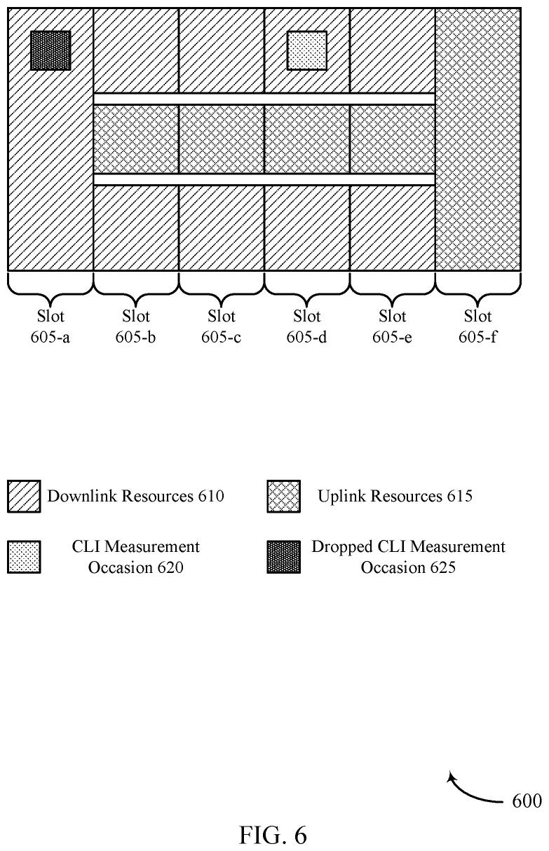

FIG. 6 shows an example of a CLI measurement scheme 600 that supports CLI measurement configurations for SBFD in accordance with one or more aspects of the present disclosure. The CLI measurement scheme 600 may implement, or be implemented by, the wireless communications systems 100 and 200 as well as the PRB selection schemes 300 through 502. For example, the CLI measurement scheme 600 may show an example of a UE 115 performing CLI measurements during one or more CLI measurement occasions, which may be examples of corresponding devices and aspects described with reference to FIGS. 1 through 5B. In some examples, the CLI measurement scheme may support the UE 115 communicating via one or more slots 605, which may include one or more half-duplex slots 605 (e.g., associated with a single communication direction) and one or more SBFD slots 605 (e.g., associated with both uplink communications and downlink communications). For example, a slot 605-a may be a half-duplex slot and may include downlink resources 610 (e.g., a downlink slot), a slot 605-b, a slot 605-c, a slot 605-d, and a slot 605-e, may be SBFD slots and may include both downlink resources 610 and uplink resources 615 (e.g., sub-bands associated with each communication direction), and a slot 605-f may be a half-duplex slot and may include uplink resources 615 (e.g., an uplink slot).

In some cases, the UE 115 may receive a configuration indicating the UE 115 is to perform CLI measurements to identify a magnitude of CLI experienced by the UE 115. For example, the UE 115 may experience CLI during SBFD slots 605 due to communications by other SBFD aware devices. The configuration may indicate one or more CLI measurement occasions 620 via which the UE 115 is to measure and report CLI values to a network entity 105 (e.g., a cell serving the UE 115). In some cases, when performing CLI measurements, the UE 115 may identify measurement PRBs via which to measure CLI according to one or more overlaps between cell-specific SBFD resources and active BWPs of the UE 115, as described with reference to FIGS. 2 through 5B.

In the example illustrated by the CLI measurement scheme 600, the CLI measurement occasions 620 may be configured to occur periodically (e.g., CLI measurement occasions 620 are available every three slots). However, performing CLI measurements during a CLI measurement occasion 620 that occurs during a half-duplex slot (such as the slot 605-a or the slot 605-f) may incur additional power consumption and/or latency at the UE 115, since CLI may not occur during half-duplex slots 605 (e.g., due to a TDD slot format being aligned between the serving cell of the UE 115 and one or more other serving cells, thereby preventing inter-cell inter-UE CLI during half-duplex slots). In such examples, the UE 115 may be configured to drop (e.g., skip, refrain from, omit, or the like) a CLI measurement occasion 620 that occurs during a half-duplex slot 605. For example, a periodic CLI measurement occasion 620 may be configured to occur during the slot 605-a (e.g., a half-duplex downlink slot), and the UE 115 may identify the CLI measurement occasion 620 as a dropped CLI measurement occasion 625. The UE 115 may skip performing CLI measurement during the dropped CLI measurement occasion 625, which may reduce power consumption, latency, or both at the UE 115 associated with performing a superfluous CLI measurement. In some examples, the UE 115 may identify that an accumulated filter is enabled for CLI measurements and the UE 115 may update the accumulated filter results when performing CLI measurements. However, the UE 115 may omit a dropped CLI measurement occasion 625 from the update process associated with the accumulated filter result (e.g., due to not performing the CLI measurement). In some examples, a subsequent periodic CLI measurement occasion 620 may occur during an SBFD slot 605, such as the slot 605-d, and the UE 115 may perform a CLI measurement during the CLI measurement occasion 620 associated with the SBFD slot 605-d.

Such techniques may support reduced power consumption and latency at the UE 115 associated with performing CLI measurements when CLI measurement occasions occur during half-duplex slots, thereby improving SBFD communications at the UE 115.

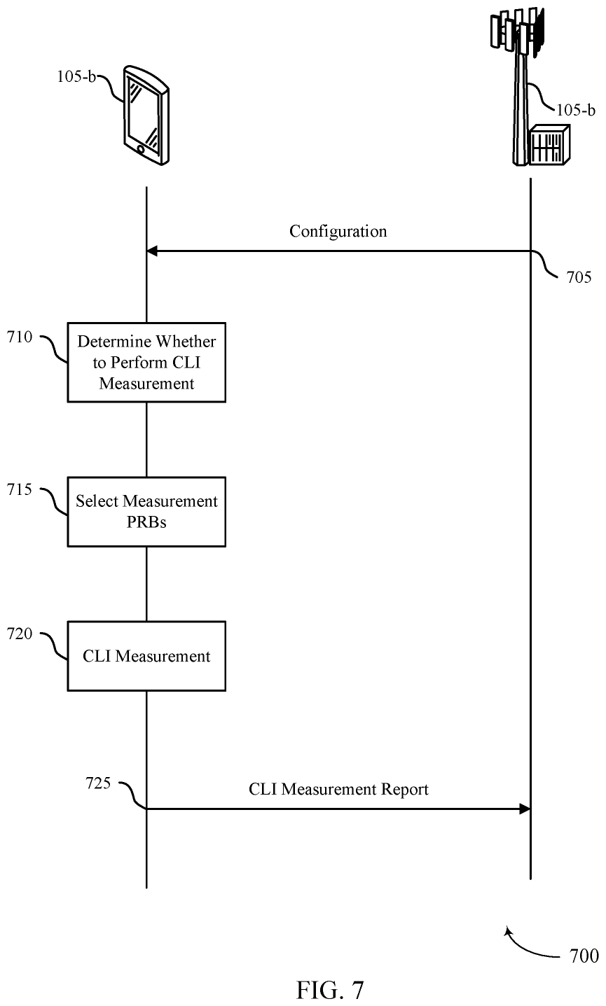

FIG. 7 shows an example of a process flow 700 that supports CLI measurement configurations for SBFD in accordance with one or more aspects of the present disclosure. The process flow 700 may implement, or be implemented by, one or more aspects of the wireless communications system 100 and 200, the PRB selection schemes 300 through 501, and the CLI measurement scheme 600. For example, the process flow 700 may show an example of signaling between a UE 115-b and a network entity 105-b, which may be examples of corresponding devices described with reference to FIGS. 1 through 6. In some examples, the process flow 700 may support the UE 115-b measuring CLI values during SBFD slots via one or more measurement PRBs, which may be examples of corresponding aspects described with reference to FIGS. 2 through 6. Alternative examples of the following may be implemented, where some processes are performed in a different order than described or are not performed. In some cases, processes may include additional features not mentioned below, or further processes may be added.

At 705, the UE 115-b may receive a message including a configuration associated with the UE 115-b performing CLI measurements. For example, the message may include an indication of one or more time domain resources (e.g., slots) associated with a CLI measurement by the UE 115-b. In some cases, the UE 115-b may receive another indication (e.g., in the same message or a prior message) of first frequency resources configured for the network entity 105-b (e.g., a cell associated with the UE 115-b) and second frequency resources configured for the UE 115-b. For example, the UE 115-b may identify that the first frequency resources are associated with an SBFD configuration such that the network entity 105-b supports communications via uplink and downlink simultaneously (e.g., using uplink sub-bands and downlink sub-bands, respectively). Additionally, the UE 115-b may identify that the second frequency resources are associated with an active BWP of the UE 115-b, such as an active uplink BWP (e.g., for the UE 115-b to use for communicating via uplink), an active downlink BWP (e.g., for the UE 115-b to use for communicating via downlink), or both. In some examples, the message may indicate a periodic configuration for CLI measurements, such that CLI measurement occasions occur via periodic slots.

At 710, the UE 115-b may determine whether to perform a CLI measurement during a slot that overlaps a first time domain resource of the one or more time domain resources (e.g., a periodically configured CLI measurement occasion). For example, the UE 115-b may identify whether the slot is a half-duplex slot (e.g., associated with a single communication direction) or an SBFD slot (e.g., including sub-bands associated with both downlink and uplink communications). If the UE 115-b determines that the slot is a half-duplex slot, the UE 115-b may skip, during the first time domain resource, a first CLI measurement occasion configured for the first time domain resource based on the slot being configured as a half-duplex slot, since CLI may not occur during half-duplex slots (as described with reference to FIG. 6). By skipping such CLI measurement occasions, the UE 115-b may reduce power expenditure and latency associated with performing unnecessary CLI measurements. In another example, if the UE 115-b determines that the slot is an SBFD slot, the UE 115-b may determine to perform CLI measurement via the slot based on the slot being configured as an SBFD slot (e.g., continuing the steps of the process flow 700).

At 715, the UE 115-b may select one or more PRBs via which to perform the CLI measurement. In some examples, the UE 115-b may select the one or more PRBs (e.g., SBFD frequency resources) according to an overlap between a first portion of the first frequency resources and the second frequency resources. As an example, the first portion of the first frequency resources may include at least one downlink sub-band and the second frequency resources may include an active downlink BWP of the UE 115-b (as described with reference to FIG. 3). In another example, the first portion of the first frequency resources may include at least one uplink sub-band and the second frequency resources may include an active uplink BWP of the UE 115-b (as described with reference to FIG. 4A). In this example, the UE 115-b may further select a subset of the one or more PRBs according to an overlap between the one or more PRBs and third frequency resources configured for the UE 115-b, where the third frequency resources may be associated with an active downlink BWP of the UE 115-b and CLI may be measured via the subset of the one or more PRBs (as described with reference to FIG. 4B). In another example, the UE 115-b may select the one or more PRBs according to an overlap between at least one uplink sub-band and an active downlink BWP of the UE 115-b (e.g., if the active downlink BWP extends beyond the active uplink BWP of the UE 115-b). In another example, the UE 115-b may select the one or more PRBs according to an overlap between one or more first portions of the first frequency resources and the second frequency resources, where the one or more first portions of the first frequency resources may include one or more guard bands configured between one or more uplink sub-bands and one or more downlink sub-bands of the first frequency resources (as described with reference to FIGS. 5A and 5B).

At 720, the UE 115-b may perform the CLI measurement via the one or more PRBs during at least one of the one or more time domain resources (e.g., a first CLI measurement occasion). For example, the UE 115-b may measure an RSSI value, an RSRP value (e.g., from an aggressor UE), or both via the one or more PRBs based on selecting the one or more PRBs. In some cases, the UE 115-b may include the CLI measurement occasion in an update process of an accumulated filter result associated with the CLI based on performing the CLI measurement. Alternatively, if the UE 115-b determined to skip the CLI measurement (e.g., at 710), the UE 115-b may skip the CLI measurement and may omit the CLI measurement occasion from the update process of the accumulated filter result.

At 725, the UE 115-b may transmit, to the network entity 105-b, a report including a CLI value based on performing the CLI measurement. In some cases, by measuring CLI via the one or more PRBs and reporting the CLI value, CLI during subsequent SBFD slots may be mitigated or otherwise reduced. Thus, such techniques may improve SBFD communications by the UE 115-b.

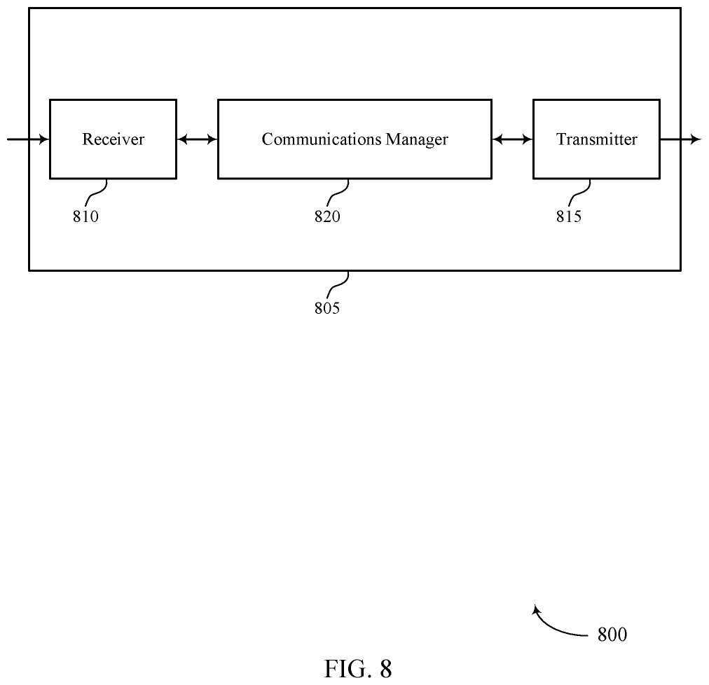

FIG. 8 shows a block diagram 800 of a device 805 that supports CLI measurement configurations for SBFD in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to CLI measurement configurations for SBFD). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to CLI measurement configurations for SBFD). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of CLI measurement configurations for SBFD as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving an indication of one or more time domain resources associated with a CLI measurement by the UE. The communications manager 820 is capable of, configured to, or operable to support a means for performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE. The communications manager 820 is capable of, configured to, or operable to support a means for transmitting a report including a CLI value in accordance with performing the CLI measurement.

Additionally, or alternatively, the communications manager 820 may support wireless communications in accordance with examples as disclosed herein. For example, the communications manager 820 is capable of, configured to, or operable to support a means for receiving an indication of one or more time domain resources associated with a CLI measurement by the UE. The communications manager 820 is capable of, configured to, or operable to support a means for skipping, during a first time domain resource of the one or more time domain resources, a first CLI measurement occasion configured for the first time domain resource in accordance with an overlap between the first time domain resource and a first slot that is configured as a half-duplex slot.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of resources and improved mitigation of interference while communicating using SBFD configurations.

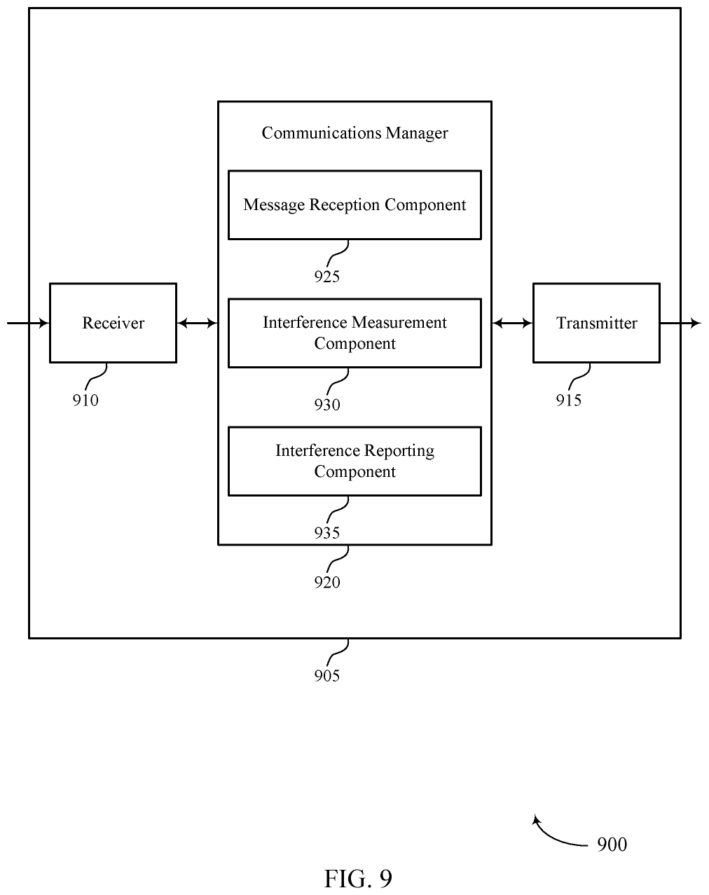

FIG. 9 shows a block diagram 900 of a device 905 that supports CLI measurement configurations for SBFD in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to CLI measurement configurations for SBFD). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to CLI measurement configurations for SBFD). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of CLI measurement configurations for SBFD as described herein. For example, the communications manager 920 may include a message reception component 925, an interference measurement component 930, an interference reporting component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The message reception component 925 is capable of, configured to, or operable to support a means for receiving an indication of one or more time domain resources associated with a CLI measurement by the UE. The interference measurement component 930 is capable of, configured to, or operable to support a means for performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE. The interference reporting component 935 is capable of, configured to, or operable to support a means for transmitting a report including a CLI value in accordance with performing the CLI measurement.

Additionally, or alternatively, the communications manager 920 may support wireless communications in accordance with examples as disclosed herein. The message reception component 925 is capable of, configured to, or operable to support a means for receiving an indication of one or more time domain resources associated with a CLI measurement by the UE. The interference measurement component 930 is capable of, configured to, or operable to support a means for skipping, during a first time domain resource of the one or more time domain resources, a first CLI measurement occasion configured for the first time domain resource in accordance with an overlap between the first time domain resource and a first slot that is configured as a half-duplex slot.

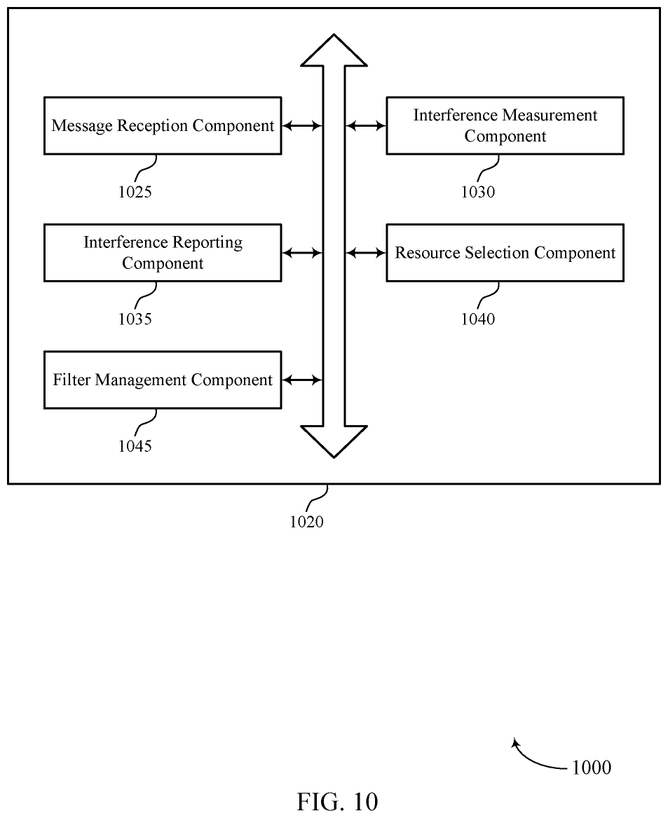

FIG. 10 shows a block diagram 1000 of a communications manager 1020 that supports CLI measurement configurations for SBFD in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of CLI measurement configurations for SBFD as described herein. For example, the communications manager 1020 may include a message reception component 1025, an interference measurement component 1030, an interference reporting component 1035, a resource selection component 1040, a filter management component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The message reception component 1025 is capable of, configured to, or operable to support a means for receiving an indication of one or more time domain resources associated with a CLI measurement by the UE. The interference measurement component 1030 is capable of, configured to, or operable to support a means for performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE. The interference reporting component 1035 is capable of, configured to, or operable to support a means for transmitting a report including a CLI value in accordance with performing the CLI measurement.

In some examples, the resource selection component 1040 is capable of, configured to, or operable to support a means for selecting the one or more PRBs in accordance with an overlap between a first portion of the first frequency resources and the second frequency resources, where the first portion of the first frequency resources include a downlink sub-band and the second frequency resources include an active downlink BWP of the UE.

In some examples, the resource selection component 1040 is capable of, configured to, or operable to support a means for selecting the one or more PRBs in accordance with an overlap between a first portion of the first frequency resources and the second frequency resources, where the first portion of the first frequency resources include an uplink sub-band and the second frequency resources include an active uplink BWP of the UE.

In some examples, the resource selection component 1040 is capable of, configured to, or operable to support a means for selecting a subset of the one or more PRBs in accordance with an overlap between the one or more PRBs and third frequency resources configured for the UE, the third frequency resources associated with an active downlink BWP of the UE, where the CLI measurement is performed via the subset of the one or more PRBs.

In some examples, the resource selection component 1040 is capable of, configured to, or operable to support a means for selecting the one or more PRBs in accordance with an overlap between one or more first portions of the first frequency resources and the second frequency resources, where the one or more first portions of the first frequency resources include one or more guard bands configured between one or more uplink sub-bands and one or more downlink sub-bands of the first frequency resources.

In some examples, to support performing the CLI measurement, the interference measurement component 1030 is capable of, configured to, or operable to support a means for measuring one or more of a RSSI and a RSRP via the one or more PRBs.

In some examples, the one or more PRBs are SBFD frequency resources.

Additionally, or alternatively, the communications manager 1020 may support wireless communications in accordance with examples as disclosed herein. In some examples, the message reception component 1025 is capable of, configured to, or operable to support a means for receiving an indication of one or more time domain resources associated with a CLI measurement by the UE. In some examples, the interference measurement component 1030 is capable of, configured to, or operable to support a means for skipping, during a first time domain resource of the one or more time domain resources, a first CLI measurement occasion configured for the first time domain resource in accordance with an overlap between the first time domain resource and a first slot that is configured as a half-duplex slot.

In some examples, the one or more time domain resources correspond to periodic CLI measurement occasions including at least the first CLI measurement occasion.

In some examples, the filter management component 1045 is capable of, configured to, or operable to support a means for omitting the first CLI measurement occasion from an update process of an accumulated filter result associated with the CLI in accordance with skipping the first CLI measurement occasion.

In some examples, the interference measurement component 1030 is capable of, configured to, or operable to support a means for performing, during a second time domain resource of the one or more time domain resources, a second CLI measurement occasion configured for the second time domain resource in accordance with an overlap between the second time domain resource and a second slot that is configured as a SBFD slot.

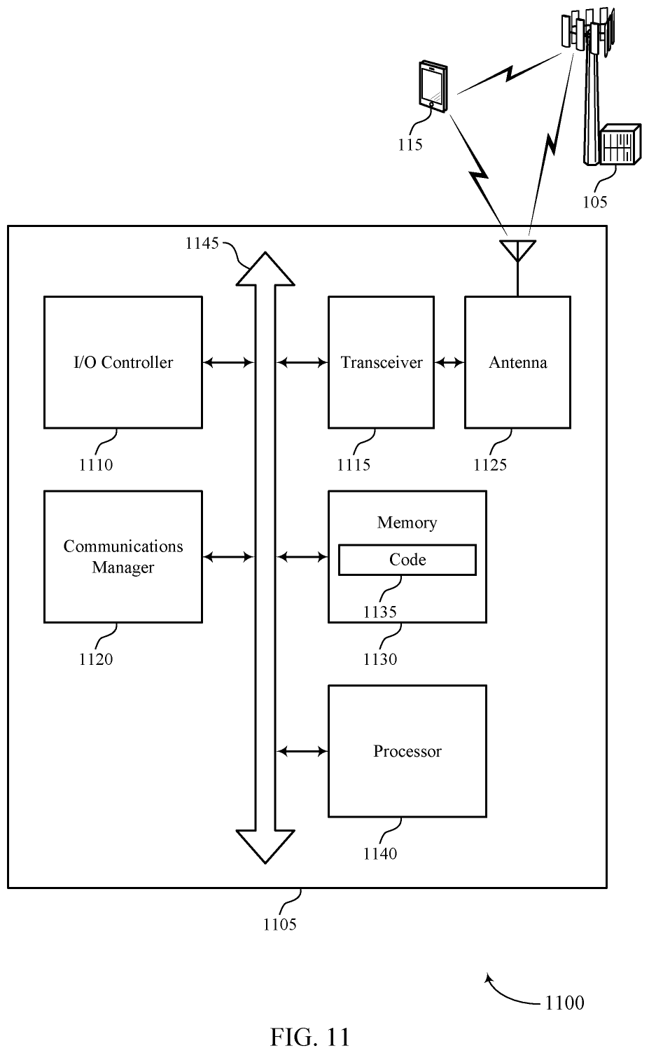

FIG. 11 shows a diagram of a system 1100 including a device 1105 that supports CLI measurement configurations for SBFD in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting CLI measurement configurations for SBFD). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving an indication of one or more time domain resources associated with a CLI measurement by the UE. The communications manager 1120 is capable of, configured to, or operable to support a means for performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE. The communications manager 1120 is capable of, configured to, or operable to support a means for transmitting a report including a CLI value in accordance with performing the CLI measurement.

Additionally, or alternatively, the communications manager 1120 may support wireless communications in accordance with examples as disclosed herein. For example, the communications manager 1120 is capable of, configured to, or operable to support a means for receiving an indication of one or more time domain resources associated with a CLI measurement by the UE. The communications manager 1120 is capable of, configured to, or operable to support a means for skipping, during a first time domain resource of the one or more time domain resources, a first CLI measurement occasion configured for the first time domain resource in accordance with an overlap between the first time domain resource and a first slot that is configured as a half-duplex slot.

By including or configuring the communications manager 1120 in accordance with examples as described herein, the device 1105 may support techniques for more efficient utilization of resources and improved mitigation of interference while communicating using SBFD configurations.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of CLI measurement configurations for SBFD as described herein, or the at least one processor 1140 and the at least one memory 1130 may be otherwise configured to, individually or collectively, perform or support such operations.

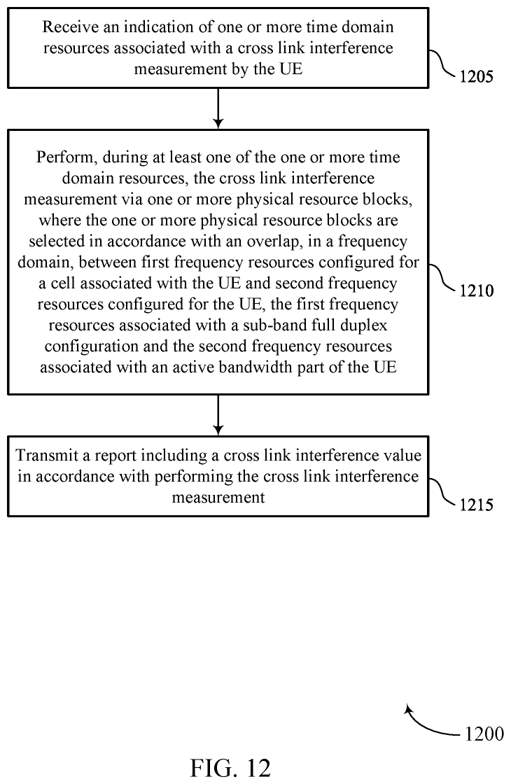

FIG. 12 shows a flowchart illustrating a method 1200 that supports CLI measurement configurations for SBFD in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving an indication of one or more time domain resources associated with a CLI measurement by the UE. The operations of 1205 may be performed in accordance with examples as disclosed herein. In some examples, aspects of the operations of 1205 may be performed by a message reception component 1025 as described with reference to FIG. 10.

At 1210, the method may include performing, during at least one of the one or more time domain resources, the CLI measurement via one or more PRBs, where the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE. The operations of 1210 may be performed in accordance with examples as disclosed herein. In some examples, aspects of the operations of 1210 may be performed by an interference measurement component 1030 as described with reference to FIG. 10.

At 1215, the method may include transmitting a report including a CLI value in accordance with performing the CLI measurement. The operations of 1215 may be performed in accordance with examples as disclosed herein. In some examples, aspects of the operations of 1215 may be performed by an interference reporting component 1035 as described with reference to FIG. 10.

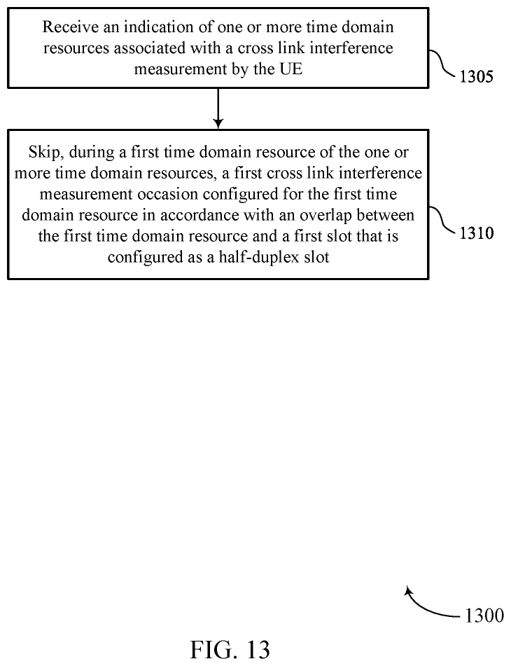

FIG. 13 shows a flowchart illustrating a method 1300 that supports CLI measurement configurations for SBFD in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving an indication of one or more time domain resources associated with a CLI measurement by the UE. The operations of 1305 may be performed in accordance with examples as disclosed herein. In some examples, aspects of the operations of 1305 may be performed by a message reception component 1025 as described with reference to FIG. 10.

At 1310, the method may include skipping, during a first time domain resource of the one or more time domain resources, a first CLI measurement occasion configured for the first time domain resource in accordance with an overlap between the first time domain resource and a first slot that is configured as a half-duplex slot. The operations of 1310 may be performed in accordance with examples as disclosed herein. In some examples, aspects of the operations of 1310 may be performed by an interference measurement component 1030 as described with reference to FIG. 10.

The following provides an overview of aspects of the present disclosure:

Aspect 1: A method for wireless communications by a UE, comprising: receiving an indication of one or more time domain resources associated with a CLI measurement by the UE; performing, during at least one of the one or more time domain resources, the CLI measurement via one or more PRBs, wherein the one or more PRBs are selected in accordance with an overlap, in a frequency domain, between first frequency resources configured for a cell associated with the UE and second frequency resources configured for the UE, the first frequency resources associated with a SBFD configuration and the second frequency resources associated with an active BWP of the UE; transmitting a report comprising a CLI value in accordance with performing the CLI measurement.

Aspect 2: The method of aspect 1, further comprising: selecting the one or more PRBs in accordance with an overlap between a first portion of the first frequency resources and the second frequency resources, wherein the first portion of the first frequency resources comprise at least one downlink sub-band and the second frequency resources comprise an active downlink BWP of the UE.

Aspect 3: The method of aspect 1, further comprising: selecting the one or more PRBs in accordance with an overlap between a first portion of the first frequency resources and the second frequency resources, wherein the first portion of the first frequency resources comprise at least one uplink sub-band and the second frequency resources comprise an active uplink BWP of the UE.

Aspect 4: The method of aspect 3, further comprising: selecting a subset of the one or more PRBs in accordance with an overlap between the one or more PRBs and third frequency resources configured for the UE, the third frequency resources associated with an active downlink BWP of the UE, wherein the CLI measurement is performed via the subset of the one or more PRBs.

Aspect 5: The method of aspect 1, further comprising: selecting the one or more PRBs in accordance with an overlap between a first portion of the first frequency resources and the second frequency resources, wherein the first portion of the first frequency resources comprise at least one uplink sub-band and the second frequency resources comprise an active downlink BWP of the UE.

Aspect 6: The method of aspect 1, further comprising: selecting the one or more PRBs in accordance with an overlap between one or more first portions of the first frequency resources and the second frequency resources, wherein the one or more first portions of the first frequency resources comprise one or more guard bands configured between one or more uplink sub-bands and one or more downlink sub-bands of the first frequency resources and the second frequency resources comprise an active downlink BWP of the UE.

Aspect 7: The method of aspect 1, further comprising: selecting the one or more PRBs in accordance with an overlap between a first portion of the first frequency resources and the second frequency resources, wherein the first portion of the first frequency resources comprise at least one uplink sub-band and the second frequency resources comprise an active downlink BWP of the UE.

Aspect 8: The method of any of aspects 1 through 7, wherein performing the CLI measurement comprises: measuring one or more of a RSSI and a RSRP via the one or more PRBs.

Aspect 9: The method of any of aspects 1 through 8, wherein the one or more PRBs are SBFD frequency resources.

Aspect 10: A method for wireless communications by a UE, comprising: receiving an indication of one or more time domain resources associated with a CLI measurement by the UE; and skipping, during a first time domain resource of the one or more time domain resources, a first CLI measurement occasion configured for the first time domain resource in accordance with an overlap between the first time domain resource and a first slot that is configured as a half-duplex slot associated with a time domain duplexing configuration.

Aspect 11: The method of aspect 10, wherein the one or more time domain resources correspond to periodic CLI measurement occasions including at least the first CLI measurement occasion.

Aspect 12: The method of any of aspects 10 through 11, further comprising: omitting the first CLI measurement occasion from an update process of an accumulated filter result associated with the CLI in accordance with skipping the first CLI measurement occasion.

Aspect 13: The method of any of aspects 10 through 12, further comprising: performing, during a second time domain resource of the one or more time domain resources, a second CLI measurement occasion configured for the second time domain resource in accordance with an overlap between the second time domain resource and a second slot that is configured as a SBFD slot.

Aspect 14: A UE for wireless communications, comprising one or more memories storing processor-executable code, and one or more processors coupled with the one or more memories and individually or collectively operable to execute the code to cause the UE to perform a method of any of aspects 1 through 9.

Aspect 15: A UE for wireless communications, comprising at least one means for performing a method of any of aspects 1 through 9.

Aspect 16: A non-transitory computer-readable medium storing code for wireless communications, the code comprising instructions executable by one or more processors to perform a method of any of aspects 1 through 9.

Aspect 17: A UE for wireless communications, comprising one or more memories storing processor-executable code, and one or more processors coupled with the one or more memories and individually or collectively operable to execute the code to cause the UE to perform a method of any of aspects 10 through 13.

Aspect 18: A UE for wireless communications, comprising at least one means for performing a method of any of aspects 10 through 13.

Aspect 19: A non-transitory computer-readable medium storing code for wireless communications, the code comprising instructions executable by one or more processors to perform a method of any of aspects 10 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processing system that includes processor circuitry and memory circuitry that stores code, the processing system configured to cause the UE to:
receive an indication of one or more time domain resources associated with a cross link interference measurement by the UE;
perform, during at least one of the one or more time domain resources, the cross link interference measurement via one or more physical resource blocks, wherein the one or more physical resource blocks are selected in accordance with an overlap, in a frequency domain, between first frequency resources configured for a cell associated with the UE and second frequency resources configured for the UE, the first frequency resources associated with a sub-band full duplex configuration and the second frequency resources associated with an active bandwidth part of the UE;
transmit a report comprising a cross link interference value in accordance with performing the cross link interference measurement.

2. The apparatus of claim 1, wherein the processing system is further configured to cause the UE to:
select the one or more physical resource blocks in accordance with an overlap between a first portion of the first frequency resources and the second frequency resources, wherein the first portion of the first frequency resources comprise at least one downlink sub-band and the second frequency resources comprise an active downlink bandwidth part of the UE.

3. The apparatus of claim 1, wherein the processing system is further configured to cause the UE to:
select the one or more physical resource blocks in accordance with an overlap between a first portion of the first frequency resources and the second frequency resources, wherein the first portion of the first frequency resources comprise at least one uplink sub-band and the second frequency resources comprise an active uplink bandwidth part of the UE.

4. The apparatus of claim 3, wherein the processing system is further configured to cause the UE to:
select a subset of the one or more physical resource blocks in accordance with an overlap between the one or more physical resource blocks and third frequency resources configured for the UE, the third frequency resources associated with an active downlink bandwidth part of the UE, wherein the cross link interference measurement is performed via the subset of the one or more physical resource blocks.

5. The apparatus of claim 1, wherein the processing system is further configured to cause the UE to:
select the one or more physical resource blocks in accordance with an overlap between a first portion of the one or more first frequency resources and the second frequency resources, wherein the first portion of the one or more first frequency resources comprises at least one uplink sub-band and the second frequency resources comprises an active downlink bandwidth part of the UE.

6. The apparatus of claim 1, wherein the processing system is further configured to cause the UE to:
select the one or more physical resource blocks in accordance with an overlap between one or more first portions of the first frequency resources and the second frequency resources, wherein the one or more first portions of the one or more first frequency resources comprise one or more guard bands configured between one or more uplink sub-bands and one or more downlink sub-bands of the one or more first frequency resources and the second frequency resources comprise an active downlink bandwidth part of the UE.

7. The apparatus of claim 1, wherein, to perform the cross link interference measurement, the processing system is configured to cause the UE to:
measure one or more of a received signal strength indicator and a reference signal received power via the one or more physical resource blocks.

8. The apparatus of claim 1, wherein the one or more physical resource blocks are sub-band full duplex frequency resources.

9. An apparatus for wireless communications at a user equipment (UE), comprising:
a processing system that includes processor circuitry and memory circuitry that stores code, the processing system configured to cause the UE to:
receive an indication of one or more time domain resources associated with a cross link interference measurement by the UE; and
skip, during a first time domain resource of the one or more time domain resources, a first cross link interference measurement occasion configured for the first time domain resource in accordance with an overlap between the first time domain resource and a first slot that is configured as a half-duplex slot associated with a time domain duplexing configuration.

10. The apparatus of claim 9, wherein the one or more time domain resources correspond to periodic cross link interference measurement occasions including at least the first cross link interference measurement occasion.

11. The apparatus of claim 9, wherein the processing system is further configured to cause the UE to:
omit the first cross link interference measurement occasion from an update process of an accumulated filter result associated with the cross link interference in accordance with skipping the first cross link interference measurement occasion.

12. The apparatus of claim 9, wherein the processing system is further configured to cause the UE to:
perform, during a second time domain resource of the one or more time domain resources, a second cross link interference measurement occasion configured for the second time domain resource in accordance with an overlap between the second time domain resource and a second slot that is configured as a sub-band full duplex slot.

13. A method for wireless communications by a user equipment (UE), comprising:
receiving an indication of one or more time domain resources associated with a cross link interference measurement by the UE;
performing, during at least one of the one or more time domain resources, the cross link interference measurement via one or more physical resource blocks, wherein the one or more physical resource blocks are selected in accordance with an overlap, in a frequency domain, between first frequency resources configured for a cell associated with the UE and second frequency resources configured for the UE, the first frequency resources associated with a sub-band full duplex configuration and the second frequency resources associated with an active bandwidth part of the UE;
transmitting a report comprising a cross link interference value in accordance with performing the cross link interference measurement.

14. The method of claim 13, further comprising:
selecting the one or more physical resource blocks in accordance with an overlap between a first portion of the first frequency resources and the second frequency resources, wherein the first portion of the first frequency resources comprise at least one downlink sub-band and the second frequency resources comprise an active downlink bandwidth part of the UE.

15. The method of claim 13, further comprising:
selecting the one or more physical resource blocks in accordance with an overlap between a first portion of the first frequency resources and the second frequency resources, wherein the first portion of the first frequency resources comprise at least one uplink sub-band and the second frequency resources comprise an active uplink bandwidth part of the UE.

16. The method of claim 15, further comprising:
selecting a subset of the one or more physical resource blocks in accordance with an overlap between the one or more physical resource blocks and third frequency resources configured for the UE, the third frequency resources associated with an active downlink bandwidth part of the UE, wherein the cross link interference measurement is performed via the subset of the one or more physical resource blocks.

17. The method of claim 13, further comprising:
selecting the one or more physical resource blocks in accordance with an overlap between a first portion of the one or more first frequency resources and the second frequency resources, wherein the first portion of the one or more first frequency resources comprise at least one uplink sub-band and the second frequency resources comprise an active downlink bandwidth part of the UE.

18. The method of claim 13, further comprising:
selecting the one or more physical resource blocks in accordance with an overlap between one or more first portions of the first frequency resources and the second frequency resources, wherein the one or more first portions of the first frequency resources comprise one or more guard bands configured between one or more uplink sub-bands and one or more downlink sub-bands of the first frequency resources and the second frequency resources comprise an active downlink bandwidth part of the UE.

19. The method of claim 13, wherein performing the cross link interference measurement comprises:
measuring one or more of a received signal strength indicator and a reference signal received power via the one or more physical resource blocks.

20. The method of claim 13, wherein the one or more physical resource blocks are sub-band full duplex frequency resources.
